(19) United States
(12) Patent Application Publication
(10) Pub. No.: US 2026/0128631 A1
(43) Pub. Date: May 7, 2026

(54) SYSTEMS FOR ROTOR COOLING

(71) Applicant: Ford Global Technologies, LLC, Dearborn, MI (US)

(72) Inventor: Adam Bangerter, Dearborn, MI (US)

(21) Appl. No.: 18/938,143

(22) Filed: Nov. 5, 2024

(51) Int. Cl. H02K 1/32

(52) U.S. Cl. CPC H02K 1/32

(57) ABSTRACT

Methods and systems are provided for cooling rotor assemblies, particularly rotor assemblies that include a shaftless rotor. In one example, a rotor assembly and cooling system includes cooling channels formed into parts of the rotor assembly, including a rotor core, an end cap, and a cup. In this way, coolant fluid flows axially through the rotor assembly to increase temperature reduction.

### FIELD

The present description relates generally to systems for providing cooling to components of a rotor assembly.

### BACKGROUND/SUMMARY

A vehicle, such as a hybrid vehicle or a fully electric vehicle (EV), may use a rotor assembly including a shaft to drive a vehicle in a direction. In previous rotor assemblies, the shaft may extend through a center of a rotor core comprising lamination stacks and be secured to the rotor core via a fastening system comprising components, such as locknuts and washers. A shoulder may be formed at a first end of the shaft, and the lamination stacks may be held together between the shoulder at the first end of the shaft and fastening components coupled to a second end of the shaft. In this way, the shaft extends axially through the lamination stacks of the rotor core to align the lamination stacks and hold the components of the rotor together.

A rotor assembly without a conventional shaft may have advantages over a conventional rotor assembly. A rotor assembly without a conventional shaft may be lighter weight and be less complex to manufacture than a conventional rotor assembly which demand a shaft. Rotor assemblies without conventional shafts may use end caps positioned at either axial end of the rotor assembly to hold laminations layers of the rotor assembly in place. It is desirable to ensure adequate cooling on rotors with endcaps.

In one example, the issues described above may be addressed by a method for a rotor assembly, comprising a first end cap; a second end cap; a rotor core surrounding a cavity and positioned between the first end cap and the second end cap; and a fastener extending axially along an axis through the first end cap, the second end cap, and the cavity, the fastener affixing the first end cap and the second end cap to the rotor core, where the first end cap and the second end cap have cap cooling channels to distribute a coolant fluid among stack cooling channels extending axially through the rotor core.

As one example, the rotor assembly may be circumferentially surrounded by a stator assembly including stator lamination stacks and conductors extending through the stator lamination stacks, the conductors including end windings extending beyond the stator lamination stacks. The cap cooling channels may further distribute fluid to the end windings. In this way, a coolant path may be provided for a rotor assembly which cools both the rotor core and stator end windings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example vehicle powertrain that may comprise a cooling system according to the present disclosure.

FIG. 2 shows a schematic diagram of a vehicle comprising the cooling system according to the present disclosure

FIG. 3 shows a cross sectional view of a rotor assembly including the cooling system according to the present disclosure.

FIG. 4A shows a perspective view of a cup of the cooling system according to the present disclosure.

FIG. 4B shows a cross sectional view of the cup of FIG. 4A according to the present disclosure.

FIG. 5 shows a perspective view of a cup of the cooling system according to the present disclosure.

FIG. 6 shows a perspective view of an outer surface of an end cap of the cooling system according to the present disclosure.

FIG. 7 shows a perspective view of an inner surface on the end cap of FIG. 6 according to the present disclosure.

FIG. 8 shows a perspective view of the rotor assembly, a stator assembly, and a cooling system according to the present disclosure.

FIG. 9 shows a perspective view of an inner surface of an end cap of the cooling system according to the present disclosure.

FIG. 10 shows a perspective view of an outer surface of an end cap of the cooling system according to the present disclosure.

FIG. 11 shows a cross sectional view of the rotor assembly according to the present disclosure.

### DETAILED DESCRIPTION

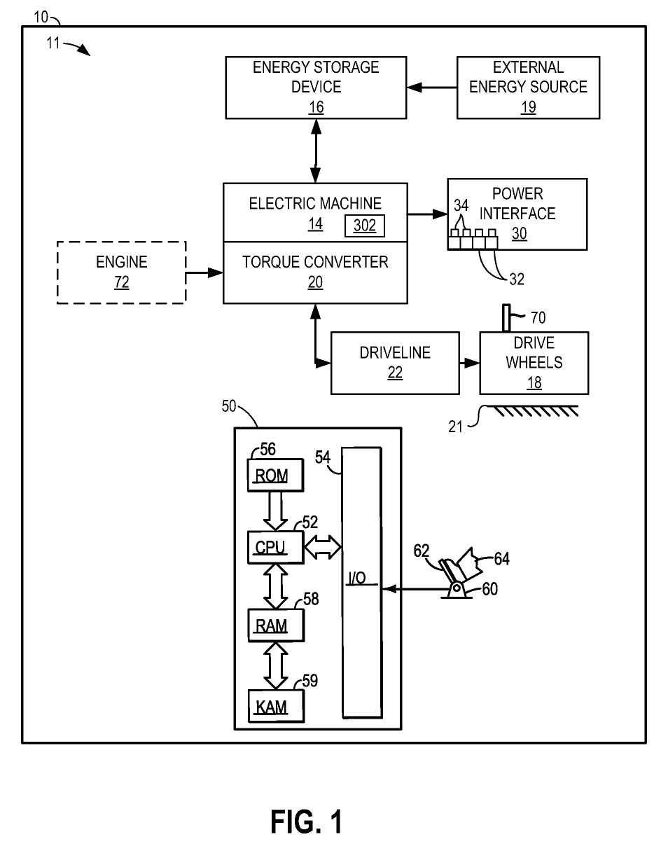

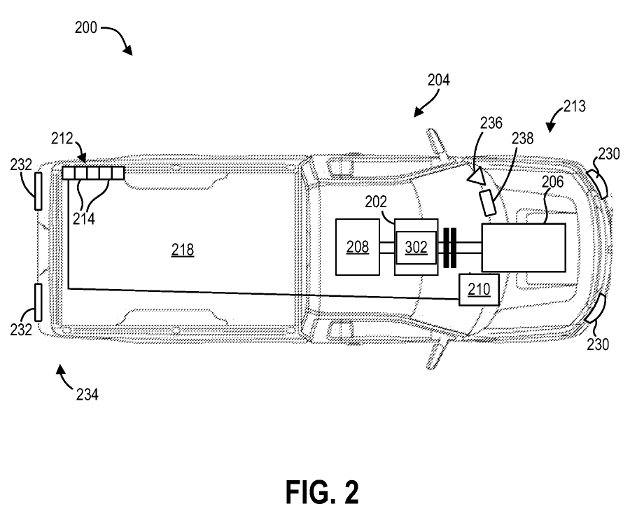

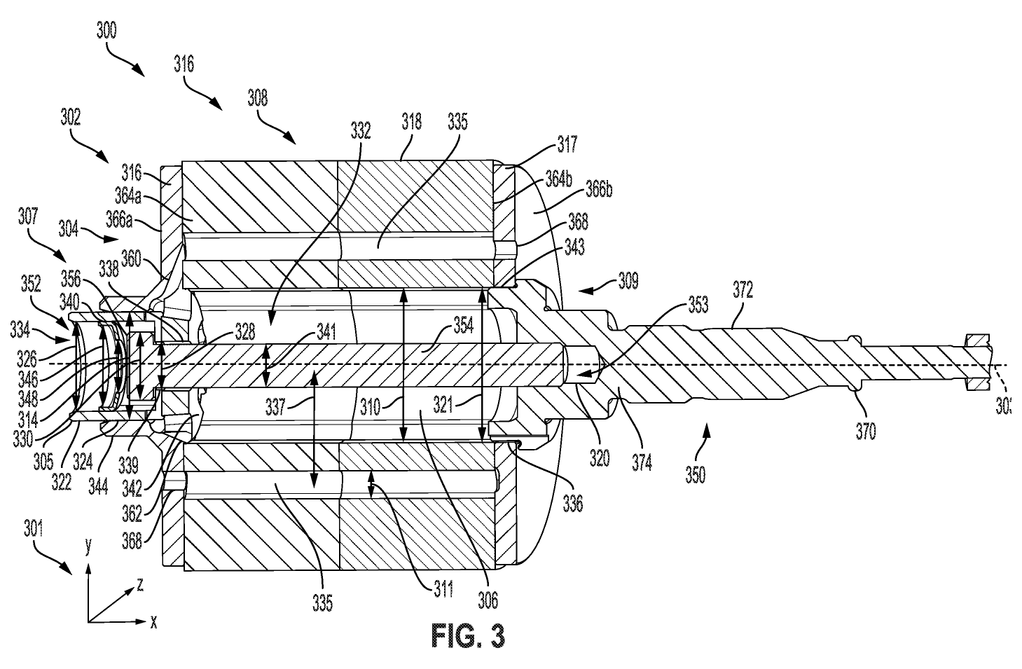

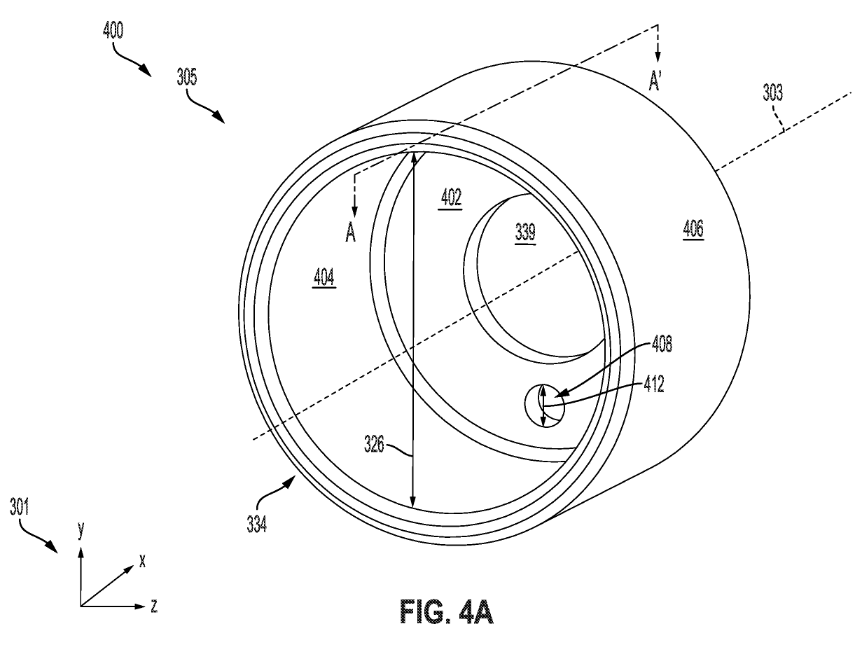

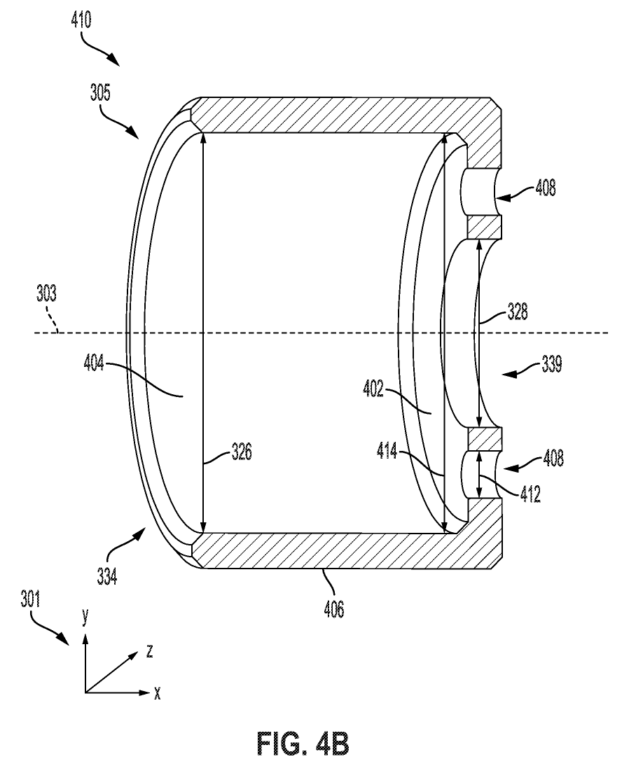

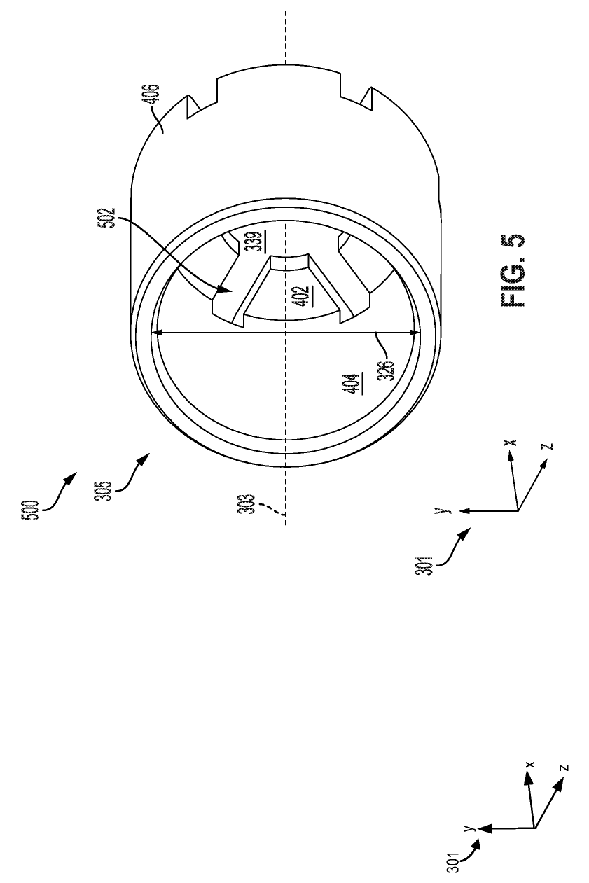

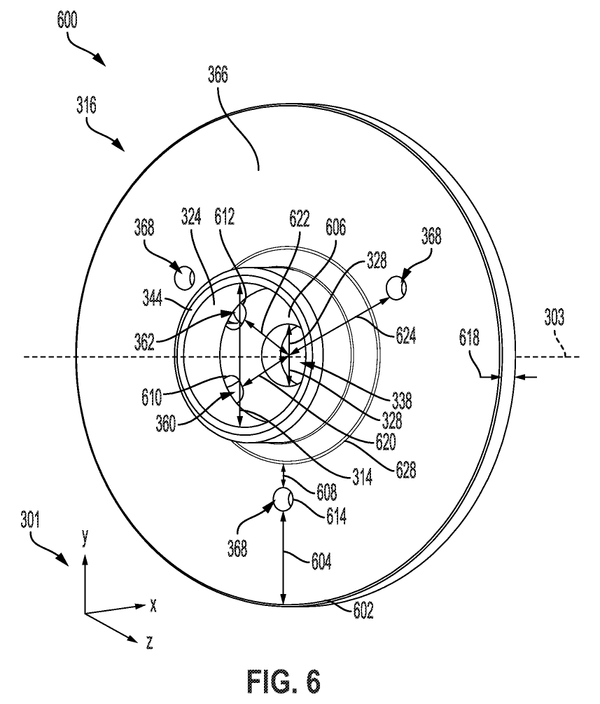

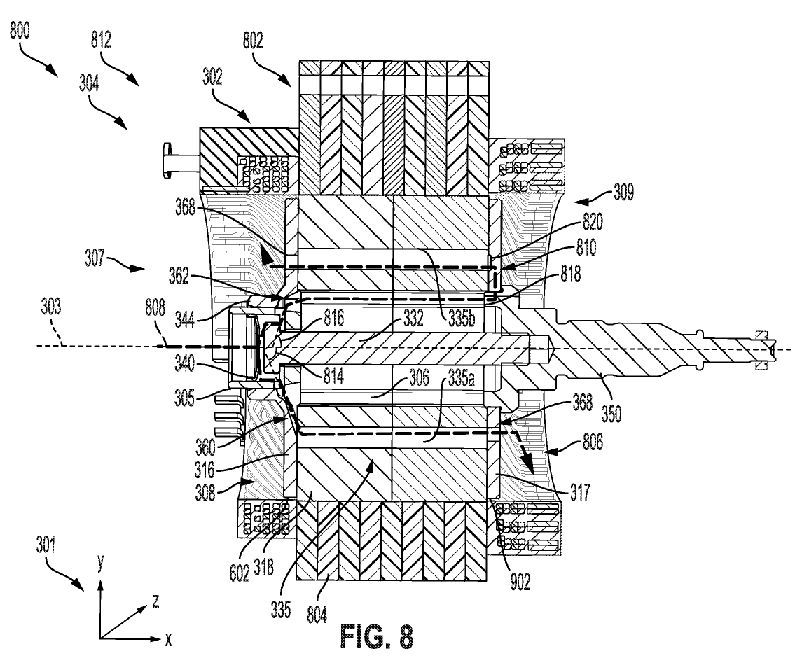

The following description relates to systems and methods for distributing coolant to a rotor assembly and a stator circumferentially surrounding the rotor assembly. The rotor assembly may include a single fastener and a shaftless rotor. The shaftless rotor may not include a rotor shaft extending therethrough. Upon fastening the shaftless rotor with the single fastener, the rotor assembly may be formed. End caps and cups positioned at either end may couple to the single fastener and in coupling to the fastener may prevent relative lateral motion of lamination layers of the shaftless rotor. A cooling system may be integrally formed in the rotor assembly to mitigate heat of both the rotor assembly and surrounding stator end windings. In one or more examples, the rotor assembly cooling system of the present disclosure may be incorporated into a vehicle, such as the vehicle shown at FIG. 2. For example, the rotor assembly cooling system may be incorporated into an electric machine of the vehicle, where the electric machine is part of the vehicle powertrain. There are various possible vehicle powertrain configurations into which the rotor assembly cooling system of the present disclosure may be incorporated, such as those shown at FIG. 1. The cooling system of the rotor assembly may provide a path for coolant through a cup, end caps, and lamination layers of the rotor assembly as shown in FIG. 3. The coolant may enter the rotor assembly through perforations in the cup. Examples of perforated cups used the cooling system are shown in FIGS. 4A, 4B, and FIG. 5. End caps may include channels configured to pass the coolant to the laminations stacks, as shown in FIGS. 6, 7 and 9-11. The cooling system, the rotor assembly, and the stator are shown in FIG. 8.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced. FIGS. 1-2 show schematics of example configurations with relative positioning of the various components. FIGS. 3-11 are shown approximately to scale, although other relative dimensions may be used. As used herein, the term “approximately” is construed to mean plus or minus five percent of the range unless otherwise specified.

Turning now to FIG. 1, an example of a vehicle 10 with a propulsion system 11 (e.g., electric propulsion system) is shown. Propulsion system 11 includes an electric machine 14 (e.g., energy conversion device). Electric machine 14 may be incorporated into an axle of vehicle 10 and may comprise a rotor assembly 302 and stator including a cooling system according to the present disclosure. Electric machine 14 is controlled via controller 50. In some examples, vehicle propulsion system 11 may further include an engine 72, where engine 72 may be an internal combustion engine.

Electric machine 14 is further shown coupled to an energy storage device 16, which may include a battery, a capacitor, inductor, or other electric energy storage device. Electric machine 14 can be operated to convert mechanical energy received from a driveline 22 into an energy form suitable for storage by the energy storage device (e.g., provide a generator operation). Electric machine 14 can also be operated to supply an output (power, work, torque, speed, etc.,) to drive wheels 18 (e.g., provide a motor operation). It should be appreciated that electric machine 14 may, in some embodiments, function only as a motor, only as a generator, or both a motor and generator, among various other components used for providing the appropriate conversion of energy between the energy storage device and drive wheels 18. For instance, electric machine 14 may include a motor, a generator, integrated starter generator, starter alternator, among others and combinations thereof. Electric machine 14 may also include or be coupled to an inverter. The inverter may be configured to condition electrical energy in and out of the energy storage device (e.g., high voltage battery). However, in other examples, vehicle 10 may not include an inverter.

Energy storage device 16 may be selectively coupled to an external energy source 19. For example, energy storage device 16 device may be periodically coupled to a charging station (e.g., commercial or residential charging station), portable energy storage device, etc., to allow energy storage device 16 to be recharged.

Electric machine 14 is coupled to a torque converter 20. Torque converter 20 is a fluid coupling designed to transfer rotational input from electric machine 14 to driveline 22. Driveline 22 includes a transmission with gearing and other suitable mechanical components (e.g., a gearbox, axles, transfer cases, etc.) designed to transfer rotational motion to drive wheels 18. Drive wheels 18 may be supported by and drive vehicle 10 across a surface 21. Torque converter 20 and electric machine 14 are depicted as an interconnected unit. However, in other examples, torque converter 20 and electric machine 14 may include discrete enclosures.

Electric machine 14 may include one or more clutches designed to selectively rotationally couple the machine’s rotor to torque converter 20. For instance, the clutch or clutches may each include plates, splines, and/or other suitable mechanical components allowing the machine to be rotationally connected as well as disconnected from the engine or the torque converter.

The depicted connections between electric machine 14, driveline 22, and drive wheel 18 indicate transmission of mechanical energy from one component to another, whereas the connections between electric machine 14 and energy storage device 16 may indicate transmission of a variety of energy forms such as electrical, mechanical, etc. For example, torque may be transmitted from electric machine 14 to vehicle drive wheels 18 via driveline 22. As described above, electric machine 14 may be configured to operate in a generator mode and/or a motor mode. In a generator mode, propulsion system 11 receives some or all of the output from electric machine 14, which reduces the amount of drive output delivered to drive wheels 18, or the amount of wheel caliper torque to drive wheels 18. Such operation may be employed, for example, to achieve energy efficiency gains through energy recovery, increased engine efficiency (if included), etc. Further, the output received by electric machine 14 may be used to charge an energy storage device 16. In motor mode, electric machine 14 may supply mechanical output to driveline 22, for example by using electrical energy stored in an electric battery. Additionally, an engine may supply rotational output to driveline 22, in some instances.

Electric machine 14 may also be used to deliver electrical energy to external, auxiliary devices during power take-off. Electric machine 14 may run during power take-off but drive wheels 18 are not in motion, allowing power output from electric machine 14 to be directed at least partially towards operating the auxiliary devices. Vehicle 10 may include a power interface 30 arranged along an electrical circuit of vehicle 10. The power interface may have a plurality of power outlets 32, each outlet electrically coupled to electric machine 14, and plugging the auxiliary devices into the plurality of outlets allows power to be supplied to the auxiliary devices. Each of power outlets 32 are coupled to or have a circuit breaker 34 integrated therein. The arrow extending between electric machine 14 and power interface 30 indicates the transfer of electrical energy therebetween. Further details of power interface 30 are described below, with reference to FIG. 2.

FIG. 1 also shows a controller 50 in vehicle 10. Controller 50 receives signals from the various sensors of FIG. 1 and employs the various actuators of FIG. 1 to adjust vehicle operation based on the received signals and instructions stored in non-transitory memory of the controller 50. The electric machine, shown in FIG. 2 as a motor generator, may also be controlled by the controller 50. Specifically, controller 50 is shown in FIG. 1 as a conventional microcomputer including: microprocessor unit 52, input/output ports 54, read-only memory 56, random access memory 58, keep alive memory 59, and a conventional data bus. Controller 50 is configured to receive various signals from sensors coupled to propulsion system 11 and send command signals to actuators in components in vehicle 10, such as the electric machine 14. Additionally, the controller 50 is also configured to receive pedal position (PP) from a pedal position sensor 60 coupled to a pedal 62 actuated by a user 64. Therefore, in one example, controller 50 may receive a pedal position signal and adjust actuators in electric machine 14 based the pedal position signal to vary the rotational output of electric machine 14. The sensors communicating with controller 50 may include an electric machine sensor (e.g., resolver or Hall effect sensor for sensing a rotor position of the electric machine), and wheel speed sensor 70, accelerometer, etc. Additionally, controller 50 may communicate electronically with one or more mobile applications. For example, a mobile application may enable the user to select stored auxiliary devices to be charged during a planned trip and based upon an electrical load profile stored in memory for the stored auxiliary devices, the mobile application may determine an amount of energy that will be spent during a planned trip. In one example, controller 50 may include computer readable instructions, that when executed cause controller 50 to measure an electrical load of one or more auxiliary devices plugged into the power interface and transmit a measurement of the electrical load to the mobile application. In another example, controller 50 may include instructions that when executed cause controller 50 to communicate one or more vehicle operating conditions to the mobile application and adjust one or more vehicle operating conditions in response to a command from the mobile application.

In examples where vehicle 10 comprises engine 72, engine 72 may have an output coupled to torque converter 20 and may be incorporated into the axle of the vehicle. Engine 72 may be controlled via controller 50. Both engine 72 and electric machine 14 may act as movers to drive the vehicle 10. For example, vehicle 10 may be a hybrid vehicle. In examples including engine 72, rotational energy in the form of torque from engine 72 or other rotational and mechanical energy from components may be converted into electrical energy by electric machine 14. The output of electric machine 14 to torque converter 20 may act as input for the transfer and transformation of torque into electrical energy during hybrid operations.

Turning now to FIG. 2, a schematic diagram 200 of an example vehicle 204 is shown. As described above, electric machine 14 of FIG. 1 may be an electric motor incorporated into an axle in some examples. In one or more examples, electric motor 202 shown in FIG. 2 may be the same or similar to electric machine 14 shown in FIG. 1. Similar to the vehicle powertrain shown at FIG. 1, vehicle 204 shown in FIG. 2 comprises rotor assembly 302, a stator, and a cooling system according to the present disclosure incorporated therein. That is, the rotor assembly 302, stator, and the cooling system are shown incorporated into electric motor 202 of vehicle 204 at FIG. 2. Additionally, vehicle 204 shown in FIG. 2 may be the same or similar to vehicle 10 shown in FIG. 1. As shown in FIG. 2, electric motor 202 may couple to an electric energy storage device 206 and a transmission 208 in a front end 213 of vehicle 204. Transmission 208 may incorporate a torque converter, in one or more examples, such as torque converter 20 shown in FIG. 1.

Vehicle 204 may also have a power interface 212 which may be disposed in a vehicle bed 218, as shown in FIG. 2. However, in other examples, power interface 212 may be positioned in some other, accessible region of the vehicle 204. Power interface 212 has a plurality of power outlets 214 configured to receive electrical plugs of electrical devices, in one or more examples.

A powertrain control module (PCM) 210 may be included, for example, in the controller 50 of FIG. 1. PCM 210 receives information from sensors arranged in a powertrain of vehicle 204 and sends instructions to actuators of the powertrain. For example, the PCM 210 may receive a signal from a resolver of electric motor 202 to infer a power output of electric motor 202 and command adjustment of output of electric motor 202, e.g., field current, according to active motor operations and electrical loads. PCM 210 may also control activation of vehicle accessories such as headlights 230, taillights 232, positioned at front end 213 and a rear end 234 of vehicle 204, respectively, a speaker or horn 236, and a cabin display panel 238. As such, illumination of headlights 230 and taillights 232 may be enabled by PCM 210 as well as emission of noises by horn 236 and presentation of alerts and notifications at cabin display panel 238.

The PCM 210 may also communicate with power interface 212 and/or an auxiliary device through a communication link. The communication link may be a wireless communication network, such as a Bluetooth ® low energy (BLE) network, allowing PCM 210 to monitor electrical and operating statuses of power interface 212 and any coupled the auxiliary devices.

Turning now to FIG. 3, a cross section view 300 of an example of a rotor assembly 302 including a cooling system 304 according to the present disclosure is shown, where rotor assembly 302 includes a rotor without a shaft. Further, in one example, rotor assembly 302 may include a single fastener 332, such as a bolt, and no other fasteners. Fastener 332 may extend through rotor assembly 302, however, fastener 332 may not perform functions of a rotor shaft, including aligning lamination stacks and drivingly coupling rotor assembly 302 to exterior components, such as gears of a transmission (e.g., transmission 208 of FIG. 2). The rotor assembly configuration according to the preset disclosure with a fastener extending therethrough and end caps adapted to align the lamination stacks may reduce weight of the rotor assembly compared to a rotor with a shaft extending therethrough, and allow for hybridization of materials such that less expensive materials may be used in combination with steel to reduce resource demand. The rotor assembly may be provided with a cooling system that may be incorporated to the cups, end caps, and lamination layers to provide heat mitigation to both the shaftless rotor and the stator circumferentially surrounding the shaftless rotor. A reference axis 301 is provided for comparison between the views of FIGS. 3-11. Reference axis 301 includes an x-axis, y-axis, and z-axis. The x-axis may be parallel to an axial direction with respect to the rotor assembly and radial directions may be perpendicular to the x-axis.

The rotor assembly 302 may comprise a cavity 306 that is centered about an axis 303. Rotor assembly 302 may rotate about axis 303 when operating as part of an electric machine of a vehicle, such as vehicle 10 of FIG. 1 or vehicle 204 of FIG. 2. Rotor assembly 302 may include a rotor core 308, rotor core 308 comprising one or more lamination stacks 318 which radially surround and define cavity 306 of rotor assembly 302. Additionally, a length of rotor assembly 302 may extend axially, parallel to axis 303, between first side 307 and second side 309. Axis 303 may be a central axis and longitudinal axis for rotor assembly 302. The axis 303 may also be the axis of rotation for rotor assembly 302.

Rotor core 308 may form a section of rotor assembly 302 between end caps, including a first end cap 316 and a second end cap 317. First end cap 316 may be located at an axially opposite end of rotor core 308 from second end cap 317. For example, first end cap 316 may be located nearest to first side 307, and second end cap 317 may be located nearest to second side 309. In this way, cavity 306 may be enclosed by end caps 316, 317 and lamination stacks 318.

Rotor core 308 may comprise a plurality of lamination stacks 318. Lamination stacks 318 and rotor core 308 may have electromagnetic properties, in one or more examples. For example, lamination stacks 318 and rotor core 308 may incorporate windings, such that lamination stacks 318 and rotor core 308 may form and act as an electromagnet when a current is applied. In some examples, lamination stacks 318 may incorporate a plurality of permanent magnets, such that lamination stacks 318 and rotor core 308 may act as part of an internal permanent magnet (IPM) electric machine. In other examples, rotor core 308 may act as part of an induction electric machine, a reluctance electric machine, and the like. The electric machine may further include a stator circumferentially surrounding rotor core 308, such as shown in FIG. 8.

In at least one example, lamination stacks 318 may comprise steel, such as silicon steel or cold formed steel. Additionally, or alternatively, lamination stacks 318 may be formed of a steel alloy, such as a nickel or cobalt alloy. In contrast with shaftless rotor assemblies wherein one or more fasteners directly physically connect with lamination stacks 318, fastener 332 of rotor assembly 302 may not physically contact lamination stacks 318. For example, lamination stacks 318 may not be in face sharing contact with fastener 332. Thus, in some examples, lamination stacks 318 may be sized and shaped as conventional lamination stacks (e.g., without modification for use in a rotor assembly according to the present disclosure).

Lamination stacks 318 may generate heat during operation of the electric machine. Cooling system 304 may include stack cooling channels 335 extending axially through lamination stacks 318, configured to flow a coolant fluid such as automatic transmission fluid (ATF) including oil (e.g., mineral, semi-synthetic, or synthetic oil) and additives (e.g., surfactants, dispersants, antioxidants, detergents, dyes, etc.). Stack cooling channels 335 may be formed by holes in each lamination layer of lamination stacks 318. The holes in the lamination layers may be axially aligned to form stack cooling channels 335. Stack cooling channels 335 may be arranged circumferentially around cavity 306. In at least some examples, lamination stacks 318 may include an even number of stack cooling channels 335. Lamination stacks 318 may be uniformly arranged around axis 303. An axial center of each of stack cooling channels 335 may be spaced a distance 337 away from an axial center of cavity 306. Each of stack cooling channels 335 may have diameter 311. Diameter 311 may be large enough to pass the coolant fluid without backpressure.

As further shown in rotor assembly 302, first end cap 316 and second end cap 317 may be fastened to rotor core 308 at axially opposite ends of rotor core 308 via fastener 332 such that first end cap 316 is in face sharing contact with rotor core 308 at first side 307 and second end cap 317 is in face sharing contact with rotor core 308 at second side 309. Specifically, inner surfaces 364 of end caps 316, 317 may be in face sharing contact with rotor core 308. For example, a first inner surface 364a and a second inner surface 364b of first end cap 316 and second end cap 317, respectively, may face axially inwards and be in face sharing contact with rotor core 308. Outer surfaces 366 of end caps 316, 317 may face axially outwards away from rotor core 308. For example, a first outer surface 366a and a second outer surface 366b of first end cap 316 and second end cap 317, respectively, may face axially outwards.

When fastened by fastener 332, end caps 316, 317 and rotor core 308 may not move laterally relative to one another. Additionally, end caps 316, 317 and rotor core 308 may be rotationally coupled via fastener 332. There may not be any other fasteners holding the components of rotor assembly 302. Fastener 332 may be the only fastener in rotor assembly 302. Thus, rotor assembly 302 may be a single fastener rotor assembly that includes a shaftless rotor fastened by a single fastener.

For example, fastener 332 may be a bolt. Fastener 332 may comprise a body 354 and a head 356. In one example, head 356 may be hexagonal in shape and physically coupled to or formed integrally with body 354 near first side 307. Fastener 332 may be positioned axially along axis 303. First end 352 of fastener 332 may extend through first end cap 316 and be partially outside of cavity 306 such that head 356 may be positioned outside of rotor core 308. A second end 353 (e.g., opposite of first end 352) of fastener 332 may extend through second end cap 317. A length of fastener 332 spanning between first end 352 and second end 353 of fastener 332 extends through cavity 306 such that fastener 332 is spaced away from walls of lamination stacks 318.

First end cap 316 may include an annular protrusion 344 adapted to receive cup 305. An inner diameter 314 of annular protrusion 344 may be slightly larger than an outer diameter of cup 305. In this way, an outer surface 322 of cup 305 may be in face sharing contact with an inner surface 324 of annular protrusion 344, where inner surface 324 is cylindrical with a diameter 314. Cup 305 may include an axially outer opening 334 and axially inner opening 339. Axially outer opening 334 may be closer to first side 307 and axially inner opening 339 may be closer to second side 309. A diameter 326 of axially outer opening 334 may be larger than a diameter 328 of axially inner opening 339. Diameter 328 may also be the diameter of through hole 338. Diameter 326 of axially outer opening 334 may be larger than a diameter 330 of head 356. Diameter 328 of axially inner opening 339 may be smaller than diameter 330 of head 356 and larger than a diameter 341 of body 354. In this way body 354 of fastener 332 may pass through cup 305 and head 356 may pass through axially outer opening 334 but not axially inner opening 339.

Second end cap 317 may include an opening 336 adapted to receive drive end coupling 350. In at least some examples, drive end coupling 350 may be adapted to drivingly couple rotor assembly 302 to a torque converter (e.g., torque converter 20 of FIG. 1) or a transmission, (e.g., transmission 208 of FIG. 2). In this way, drive end coupling 350 may act as the torque transmission spline through which torque may be transferred between rotor assembly 302 and an external component (not shown). For example, the external component may be a component of a transmission (e.g., as gear), such as transmission 208 of FIG. 2. In another example, the external component may be a torque converter, such as torque converter 20 of FIG. 1. Drive end coupling 350 may be shaped with one or more of protrusions (e.g., protrusion 370), splines (e.g., spines 372), indents (e.g., indent 374), and the like along the exterior surface of drive end coupling 350 which may fit to a shape of the external component to which drive end coupling 350 connects. In this way, drive end coupling 350 may rotationally couple rotor assembly 302 and the external component. In other examples, drive end coupling 350 may be shaped differently than as shown, according to the geometry of the external component to which drive end coupling 350 rotationally couples to.

The first end cap 316 may comprise a first flange 342 and drive end coupling 350 may comprise a second flange 343. First flange 342 and second flange 343 may extend axially inward towards rotor core 308. That is, first flange 342 and second flange 343 may extend axially towards each other. second flange 343 may extend through and beyond opening 336. First flange 342 and second flange 343 may further be centered about axis 303 of rotor assembly 302. First flange 342 and second flange 343 may be cylindrical in shape. In this way, first flange 342 and second flange 343 may form ring shaped extensions from first end cap 316 and drive end coupling 350, respectively. Flanges 342, 343 may have an outer diameter 321, wherein outer diameter 321 is approximately the same as inner diameter 310. In this way first flange 342 and second flange 343 may align lamination stacks 318. Therefore, a shaft is not demanded to align lamination stacks 318.

The second end 353 of fastener 332 may extend through opening 336 formed through second end cap 317, and first end 352 of fastener 332 may extend through through hole 338 formed into first end cap 316. Additionally, first end 352 of fastener 332 may extend through opening 339 formed into cup 305, and second end 353 of fastener 332 may extend into a recess 320 located centrally along axis 303 in drive end coupling 350. In some examples, fastener 332 may be removably coupled to recess 320 via threading, pins, and the like. In other examples, fastener 332 may be coupled to recess 320 via welding or other permanent fastening techniques. Opening 336 may be larger than through hole 338 in at least some examples so as to receive drive end coupling 350 circumferentially surrounding body 354 of fastener 332, whereas opening 336 may be sized to receive body 354.

In at least some examples, head 356 may apply a first axial force towards rotor core 308, and drive end coupling 350 may apply a second axial force towards rotor core 308, such that the first axial force and the second axial force are oriented opposite of one another. For example, the first axial force may be in the positive x-direction and the second axial force may be in the negative x-direction. The opposing axial forces may result in compression of rotor assembly 302. Thus, fastener 332 may apply axial force to fasten (e.g., rotationally couple and axially affix) the components of the shaftless rotor with drive end coupling 350 to form rotor assembly 302. In this way, fastener 332 may extend axially through cavity 306 of rotor core 308, end caps 316, 317, cup 305, and drive end coupling 350 to pull first end cap 316 and second end cap 317 towards each other, thereby compressively holding first end cap 316, lamination stacks 318, and second end cap 317 together to form rotor assembly 302.

A fluid plug 340 may be positioned within cup 305 such that fluid plug 340 is axially spaced away from head 356. Fluid plug 340 may axially taper from a first diameter 346 to a second diameter 348. First diameter 346 may be large enough that a radially outer surface of fluid plug 340 is in face sharing contact with a radially inner surface of cup 305. Second diameter 348 may be smaller than first diameter 346 such that an axially inner opening of fluid plug 340 is smaller than an axially outer opening of fluid plug 340. In this way, fluid plug 340 may taper axially inwards towards axis 303, forming a bend in fluid plug 340. Second diameter 348 may be smaller than diameter 330 of head 356. Fluid plug 340 may reduce backflow of fluid. For example, fluid may flow into cup 305 via axially outer opening 334 and through fluid plug 340 axially towards fastener 332. However, due to rotation of rotor assembly 302, fluid may be forced to the inner surface of cup 305 (e.g., inner surface 404 of FIGS. 4A-5) and thus the fluid plug 340 may block backflow of the fluid towards the axially outer opening 334.

First end cap 316 may further include a first cooling channel 360, a second cooling channel 362, and a third cooling channel 368. First cooling channel 360 may fluidly couple cup 305 to stack cooling channels 335. Second cooling channel 362 may fluidly couple cup 305 to cavity 306. Third cooling channel 368 may fluidly couple stack cooling channel 335 with an area outside of rotor assembly 302. There may be more than one first cooling channel 360 formed into first end cap 316. Likewise, there may be more than one second cooling channel 362 formed into first end cap 316. Similarly, there may be more than one third cooling channel 368 formed into first end cap 316. Second end cap 317 may also include one or more first cooling channels 360. The end cap cooling channels, including first cooling channel 360, second cooling channel 362, and third cooling channel 368, are described further below in regards to FIGS. 6-11. Additionally, second end cap 317 may include further cooling channels as described further with regards to FIG. 8.

Turning to FIGS. 4A and 4B, an example of cup 305 is shown in a first view 400 and a second view 410, respectively. The second view 410 may be a cross section taken along segment A-A’ shown in the first view 400.

Cup 305 may be hollow cylindrical shaped with a plurality of openings, including axially inner opening 339 and axially outer opening 336 as described above. A fastener such as fastener 332 of FIG. 3 may extend through opening 339 and abut annular surface 402 of cup 305. The cylindrical wall of cup 305 may be tapered between axially outer opening 336 and axially inner opening 339 such that outer diameter 414 of annular surface 402 is smaller than diameter 326 of axially outer opening 334. Inner surface 404 may be in face sharing contact with a fluid plug such as fluid plug 340 of FIG. 3. Outer surface 406 may be in face sharing contact with a protrusion of an end cap, such as protrusion 344 of end cap 316 in FIG. 3.

Cup 305 may also include cooling holes 408 radially arranged about opening 339. For example, there may be two cooling holes 408. However, in other examples there may be more than two cooling holes 408 uniformly radially distributed around axis 303. Cooling holes 408 may have diameter 412. Diameter 412 may be smaller than diameter 328. Cooling holes 408 may be spaced away from opening 339. Thus, cooling holes 408 may be fluidly separated from opening 339. Further, cooling holes 408 may be spaced away from inner surface 404. Cooling holes 408 may allow coolant fluid to flow axially through cup 305. That is, coolant fluid may flow through opening 334, through cooling holes 408, and into cooling channels formed in an end cap, such as first cooling channel 360 and second cooling channel 362 of FIG. 3.

Turning to FIG. 5, a view 500 shows another example of cup 305. A plurality of cooling slots 502 may be formed into cup 305. Cooling slots 502 may extend radially from opening 339 outwards to inner surface 404 and axially along the cylindrical wall of cup 305, including inner surface 404 and outer surface 406. For example, there may be four cooling slots 502. In other examples, there may be more or fewer than four cooling slots radially arranged about opening 339. Cooling slots 502 may be uniformly radially distributed with respect to axis 303. Cooling slots 502 may be rectangular-shaped in some examples, as shown in FIG. 5. In other examples, cooling slots 502 may have other shapes, including rounded corners, cut outs, and other modifications to rectangular shapes.

Cooling passages, including cooling slots such as cooling slots 502 and/or cooling through holes such as cooling holes 408 of FIGS. 4A and 4B, may be formed into cup 305 to allow fluid flow axially through cup 305 despite opening 339 being at least partially blocked by a fastener such as fastener 332 of FIG. 3 extending therethrough. Further, cooling passages in cup 305 may axially align with through holes in an end cap which is adapted to receive cup, such as end cap 316 of FIG. 3.

Turning to FIG. 6, a first view 600 is shown of an example of end cap 316. End cap may include the protrusion 344 adapted to receive cup 305 of FIGS. 3, 8 and, 11 such that cup 305 is in face sharing contact with inner surface 324 and abuts an annular portion 606 of outer surface 366 that is circumferentially surrounded by protrusion 344.

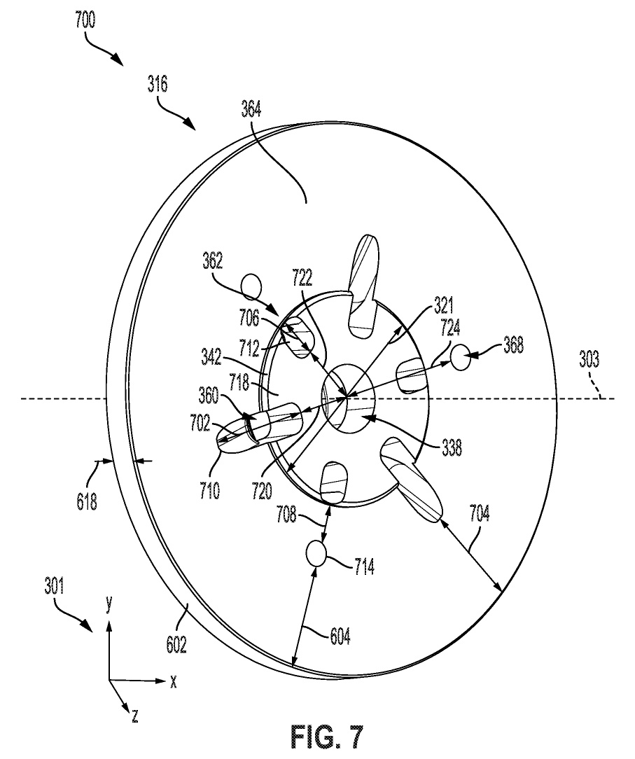

As described above, first end cap 316 may further include through hole 338 centered around axis 303, first cooling channels 360, second cooling channels 362, and third cooling channels 368. Through hole 338 may be a single circular through hole centered around axis 303 and adapted to receive fastener 332 of FIGS. 3, 8, and 11. As an example, there are three first cooling channels 360, three second cooling channels 362, and three third cooling channels 368 shown in FIGS. 6 and 7. However, in other examples, there may be different numbers of each cooling channels. There may be two or more first cooling channels 360, two or more second cooling channels 362, and two or more third cooling channels 368. In at least some examples, a first number of first cooling channels 360, a second number of second cooling channels 362, and a third number of third cooling channels 368 may be equal. The numbers and arrangement of cap cooling channels in first end cap 316 may correspond to a number and arrangement of stack cooling channels 335 in lamination stacks 318 of FIGS. 3, 8, and 11, as well as cap cooling channels in second end cap 317, in order to axially align therewith as described above.

The cap cooling channels in first end cap 316, including first cooling channels 360, second cooling channels 362, and third cooling channels 368, may extend through an entire thickness 618 of first end cap 316. That is, the cap cooling channels in first end cap 316 may be through holes, each extending between a first opening in inner surface 364 and a second opening in outer surface 366. First cooling channels 360 may each extend axially through first end cap 316 from a first outer opening 610 in outer surface 366 to a first inner opening 710 in inner surface 364 shown in FIG. 7. Likewise, second cooling channels 362 may each extend axially through first end cap 316 from a second outer opening 612 in outer surface 366 to a second inner opening 712 in inner surface 364 shown in FIG. 7. Similarly, third cooling channels 368 may each extend axially through first end cap 316 from a third outer opening 614 in outer surface 366 to a third inner opening 714 in inner surface 364 shown in FIG. 7. Third outer openings 614 may be circular. First outer openings 610 and second outer openings 612 may be partial circle shaped. For example, due to first cooling channels 360 and second cooling channels 362 intersecting protrusion 344, first outer openings 610 and second outer openings 612 may be circles partially blocked by protrusion 344, forming roughly semicircular shapes or other modified partial circle, oval, or other rounded shapes.

First cooling channels 360 may be uniformly radially arranged around through hole 338 equidistantly from axis 303, by a first outer distance 620. First cooling channels 360 may be spaced away from through hole 338. Specifically, first outer openings 610 may be spaced away from through hole 338. First outer openings 610 may intersect inner surface 324 of protrusion 344. Similarly, second cooling channels 362 may be uniformly radially arranged around through hole 338 equidistantly from axis 303, by a second outer distance 622. Second cooling channels 362 may be spaced away from through hole 338. Specifically, second outer openings 612 may be spaced away from through hole 338. Second outer openings 612 may intersect inner surface 324 of protrusion 344. In some examples, first outer distance 620 between axis 303 and first cooling channels 360 may be approximately the same as second outer distance 622 between axis 303 and second cooling channels 362. In such examples, first cooling channels 360 may alternate with second cooling channels 362 in a ring-shaped pattern around through hole 338. Further, first cooling channels 360 and second cooling channels 362 may be uniformly radially distributed to balance (e.g., symmetrize) mass around rotational axis 303.

Third cooling channels 368 may be radially aligned with second cooling channels 362. As such, there may be two or more third cooling channels 368 uniformly radially arranged around through hole 338 equidistantly from axis 303 by a third outer distance 624. Distance 624 may be sized according to distance 337 of FIG. 3 such that third cooling channels 368 axially align with stack cooling channels 335 of FIGS. 3, 8, and 11 to form a continuous channel including stack cooling channels 335 and third cooling channels 368. For example, distance 624 may be less than or approximately equal to distance 337. Third cooling channels 368 may be radially further from axis 303 than first cooling channels 360 and second cooling channels 362. Said another way, third outer distance 624 may be greater than second outer distance 622. Additionally, third outer distance 624 may be greater than first outer distance 620. Third cooling channels 368, and more particularly third outer openings 614, may be spaced away from an angled surface 628 of protrusion 344 by a distance 608, where the angled surface 628 connects protrusion 344 to outer surface 366. Third cooling channels 368 may be radially further from axis 303 than protrusion 344 so as to align with stack cooling channels 335 of FIGS. 3, 8, and 11. Additionally, third cooling channels 368, specifically third outer openings 614, may be spaced away from outer edge 602 of end cap 316 by a non-zero distance 604. Distance 604 may be greater than distance 608, in at least some examples.

In this way, coolant fluid may flow axially through first end cap 316 via cap cooling channels including first cooling channels 360, second cooling channels 362, and third cooling channels 368, but may not be allowed to flow radially out of first end cap 316 (e.g., via radially outer edge 602).

Turning to FIG. 7, a second view 700 is shown of the example of first end cap 316 of FIG. 6. As described above with regards to FIG. 3, first end cap 316 may include first flange 342 protruding from inner surface 364 and adapted to align lamination stacks 318 of FIGS. 3, 8, and 11. Flange inner surface 718 may be a raised (e.g., protruding) surface with respect to inner surface 364. Flange inner surface 718 may be parallel with inner surface 364. Further, as described above, diameter 321 of first flange 342 (and second flange 343 of FIGS. 3 and 8) may be greater than diameter 314 of protrusion 344 shown in FIGS. 3 and 6. First cooling channels 360, second cooling channels 362, and third cooling channels 368 may include first inner openings 710, second inner openings 712, and third inner openings 714, respectively, formed in inner surface 364.

First inner openings 710 may be spaced away from axis 303 by a first inner distance 720. In some examples, first inner distance 720 may be approximately the same as first outer distance 620 of FIG. 6. In other examples, first inner distance 720 may be less than first outer distance 620. First inner openings 710 may be radially elongated, extending across inner surface 364 and flange inner surface 718. For example, first inner openings 710 may be radially elongated compared to first outer openings 610 of FIG. 6. Specifically, first inner openings 710 may be radially outwardly elongated such that coolant fluid flowing through first cooling channels 360 (into first outer openings 610 of FIG. 6 and out of first inner openings 710) may flow at a first angle (e.g., non-perpendicular angle such as first angle 814 of FIG. 8) with axis 303 (e.g., neither axially nor directly radially). Consequently, fluid may flow from first cooling channels 360 to stack cooling channels 335, as described above with regards to FIG. 3.

Second inner openings 712 may be spaced away from axis 303 by a second inner distance 722. In some examples, second inner distance 722 may be approximately the same as second outer distance 622 of FIG. 6. In other examples, second inner distance 722 may be less than second outer distance 622. Additionally, in some examples, second inner distance 722 may be approximately equal to first inner distance 720. Second inner openings 712 may extend along surface 718. Similar to first inner openings 710, second inner openings 712 may also be outwardly radially elongated. For example, second inner openings 712 may be radially elongated compared to second outer openings 612 of FIG. 6. Second inner openings 712 may be less elongated than first inner openings 710. For example, a first radial dimension 702 of first inner openings 710 may be greater than a second radial dimension 706 of second inner openings 712. In this way, fluid may flow through second cooling channels 362 with a path at a second angle (e.g., non-perpendicular angle such as second angle 816 of FIG. 8) with axis 303, the second angle being greater than the first angle by which fluid flows through first cooling channels 360. Consequently, fluid may be directed by second cooling channels 362 to a radially inner path compared to first cooling channels 360. For example, as described above, second cooling channels 362 may direct fluid towards cavity 306 of FIGS. 3, 8, and 11 while first cooling channels 360 may direct fluid towards stack cooling channels 335 of FIGS. 3, 8, and 11 which are located radially outward relative to cavity 306.

Third inner openings 714 may not be elongated such that third inner openings 714 are approximately the same size and shape as third outer openings 614 of FIG. 6. Third inner openings 714 may be spaced away from flange 342 by a distance 708. Distance 708 may be less than distance 608 of FIG. 6 in examples where diameter 321 is greater than diameter 314 of FIGS. 3 and 6. Additionally, third inner openings 714 may be equidistantly spaced away from axis 303 by a distance 724, where the distance 724 may be approximately the same as the distance 624 of FIG. 6. Further, third inner openings 714 may be equidistantly spaced away from radially outer edge 602 by distance 604. Distance 604 may be approximately the same as a distance 704 by which first inner openings 710 are spaced away from radially outer edge 602, in some examples. In such examples, a sum of distance 720 and first radial dimension 702 may be approximately equal to distance 704, and approximately equal to distance 604. In this way, third cooling channels 368 may direct fluid in an axial direction, parallel with axis 303.

Coolant fluid may enter/exit first end cap 316 via first inner openings 710, second inner openings 712, and third inner openings 714. Likewise, coolant fluid may enter/exit first end cap via first outer openings 610, second outer openings 612, and third outer openings 614 of FIG. 6. In one example of a coolant fluid flow path, referencing FIGS. 6 and 7, coolant fluid may enter first end cap 316 via first outer openings 610, second outer openings 612, and third inner openings 714. Coolant fluid may exit first end cap 316 via first inner openings 710, second inner openings 712, and third outer openings 614. An exemplary flow path of coolant fluid through first end cap 316 and other components is described further below in regards to FIG. 8.

Turning to FIG. 8, a cross section view 800 is shown of an electric machine 812 that includes rotor assembly 302, cooling system 304, and a stator assembly 802 circumferentially surrounding rotor core 308. Electric machine 812 may be an example of electric machine 14 of FIG. 1 and/or electric motor 202 of FIG. 2. A path 808 is shown for flow of coolant fluid through electric machine 812.

Stator assembly 802 may include a stator core comprising stator lamination stacks 804. Stator lamination stacks 804 may include stacks of stator lamination layers centered around axis 303. An axial length of stator lamination stacks 804 may be approximately the same as an axial length of lamination stacks 318. In this way, lamination stacks 318 may be circumferentially surrounded by stator lamination stacks 804.

Stator assembly 802 may further include conductors extending through stator lamination stacks 804. The conductors may include end windings 806 extending beyond stator lamination stacks 804 on either end of stator assembly 802. Heat may accumulate in the conductors during operation of electric machine 14. Heat may also accumulate in rotor assembly 302. Thus, cooling of end windings 806 may be demanded, in addition to at least some parts of rotor assembly 302. Cooling system 304 of the present disclosure may deliver coolant fluid to at least some parts of rotor assembly 302 and end windings 806, as described below.

Coolant fluid may enter rotor assembly 302 via cup 305. For example, a pump may deliver fluid to axially outer opening 334 of cup 305. Coolant fluid may travel axially from axially outer opening 334 through cup 305 towards cavity 306. Head 356 of fastener 332 may at least partially block fluid from flowing through opening 339 and through hole 338. Thus, coolant fluid may flow through cup via cooling passages, where the cooling passages may include cooling holes fluidly separated from opening 339, such as cooling holes 408 of FIGS. 4A and 4B, and/or cooling slots fluidly coupled with opening 339 such as cooling slots 502 of FIG. 5.

Cooling system 304 may include cooling channels, including stack cooling channels and cap cooling channels, adapted to facilitate coolant fluid flow axially through rotor core 308. Specifically, the cap cooling channels may distribute coolant fluid among stack cooling channels 335 extending axially through rotor core 308. Cooling system 304 may not allow for radial flow within rotor core 308. Thus, in at least some examples, coolant fluid does not flow radially within rotor core 308. For example, cap cooling channels in first end cap 316 and second end cap 317 may distribute coolant fluid to stack cooling channels 335 and cavity 306 where fluid may flow in axial paths. In this way, coolant fluid may be blocked from radially flowing outwards through lamination stacks 318 towards a gap (e.g., air gap) between rotor core 308 and stator lamination stacks 804. Further, cap cooling channels may all be spaced away from outer edges of first end cap 316 and second end cap 317 (e.g, outer edge 602 of FIGS. 6 and 7) such that coolant fluid does not exit first end cap 316 or second end cap 317 radially via the outer edges. The cap cooling channels in first end cap 316 and second end cap 317 may include first cooling channels 360, second cooling channels 362, and third cooling channels 368. Such cooling channels may be shaped as described above with regards to FIGS. 6 and 7. First cooling channels 360 and second cooling channels 362 may provide angled (e.g., not axial nor radial) coolant paths with respect to axis 303. Third cooling channels 368 may provide axial coolant paths parallel with axis 303. The cap cooling channels may further include fourth cooling channels 810 configured to redirect coolant flow to an opposite axial direction from that at which fluid enters fourth cooling channels 810.

Coolant fluid may enter rotor assembly 302 via cup 305. Coolant fluid may flow from cup 305 into first cooling channels 360 and second cooling channels 362 in first end cap 316. For example, coolant fluid may flow through cooling passages in cup 305 to first cooling channels 360 and second cooling channels 362 in first end cap 316. The cooling passages in cup 305 may include cooling holes (e.g., cooling holes 408 of FIGS. 4A and 4B) and/or cooling slots (e.g., cooling slots 502 of FIG. 5). As described above, first cooling channels 360 may fluidly couple cup 305 with stack cooling channels 335 and second cooling channels 362 may fluidly couple cup 305 with cavity 306. Therefore, first cooling channels 360 and second cooling channels 362 may axially align with the cooling holes and/or cooling slots of cup 305.

As such, coolant fluid path 808 may flow at a first angle 814 with axis 303 through first cooling channels 360 into stack cooling channels 335 and travel axially towards second end cap 317 where coolant fluid may flow into third cooling channels 368 formed in second end cap 317. Thus, stack cooling channels 335 may be axially aligned with first cooling channels 360 in first end cap 316 and third cooling channels 368 in second end cap 317. In this way, coolant fluid may exit rotor assembly 302 after following a first portion of path 808 through cup 305 (e.g., via cooling channels and/or cooling slots), first cooling channels 360 in first end cap 316, stack cooling channels 335, and third cooling channels 368 in second end cap 317. The first angle 814 may not be a radial or axial direction with respect to axis 303.

Additionally, coolant fluid path 808 may concurrently flow through second cooling channels 362 at a second angle 816 with axis 303 into cavity 306 and travel axially towards second end cap 317 where coolant fluid may flow into fourth cooling channels 810 formed in second end cap 317. As such, second cooling channels 362 may be axially aligned with fourth cooling channels 810.

Similar to first angle 814, second angle 816 may not be perpendicular nor parallel with axis 303 such that fluid does not flow directly radially or directly axially through second cooling channels 362 or first cooling channels 360. Second angle 816 may be greater than first angle 814, in at least some examples. In this way, coolant fluid may be delivered to different radial distances from axis 303 by the first cooling channels 360 and the second cooling channels 362. Therefore, the cap cooling channels, including the first cooling channels 360 and the second cooling channels 362, may be adapted to distribute coolant fluid to stack cooling channels 335 and cavity 306.

Due to rotation of rotor assembly 302 and second cooling channels 362 guiding fluid radially outwards, coolant fluid in cavity 306 may flow around perimeter of cavity 306 (e.g., across surfaces of lamination stacks 318 defining cavity 306), rather than flowing through cavity 306 in contact with fastener 332. For example, fourth cooling channels 810 may include a first opening 818 formed in drive end coupling 350 and a second opening 820 formed in inner surface 364b of second end cap 317, where second opening 820 is radially further from axis 303 than first opening 818. First opening 818 and second opening 820 may be connected via through holes extending radially therebetween through drive end coupling 350 and second end cap 317. Fourth cooling channels 810 may not intersect outer surface 366b such that fluid does not exit rotor assembly 302 via fourth cooling channels 810. Fourth cooling channels 810 may direct coolant fluid radially outwards and axially into stack cooling channels 335, towards first end cap 316 where coolant fluid may flow through third cooling channels 368 in first end cap 316. In this way, coolant fluid may exit rotor assembly 302 after following a second portion of path 808 through cup 305 (e.g., via cooling holes and/or cooling slots), second cooling channels 362 in first end cap 316, cavity 306, fourth cooling channels 810 in second end cap 317, stack cooling channels 335, and third cooling channels 368 in first end cap 316.

Each stack cooling channel 335 may axially align with either first cooling channels 360 of first end cap 316 or fourth cooling channels of second end cap 317. Coolant fluid may flow in a first axial direction (e.g., positive x-direction) through some stack cooling channels 335 and in a second axial direction (e.g., negative x-direction) through other stack cooling channels 335. In other words, coolant fluid may flow in a first axial direction through some of the stack cooling channels 335 and in a second axial direction through others of the stack cooling channels 335, where the first axial direction is opposite the second axial direction. For example, for stack cooling channels 335a that are axially aligned with first cooling channels 360 in first end cap 316 and third cooling channels 368 in second end cap 317, coolant fluid may flow therethrough in the positive x-direction. In such an example, for stack cooling channels 335b that are axially aligned with second cooling channels 362 in first end cap 316 and fourth cooling channels 810 in second end cap 317, coolant fluid may flow therethrough in a negative x-direction.

Path 808 may bend away from axis 303 as coolant fluid exits rotor assembly 302 via third cooling channels 368 in first end cap 316 and second end cap 317. For example, due to rotation of rotor assembly 302 about axis 303, coolant fluid may be centrifugally compelled away from axis 303 upon release from radial constriction within the axially oriented stack cooling channels 335. In this way, coolant fluid may be directed radially outward, towards end windings 806. Thus, cooling system 304 may distribute fluid to stack cooling channels 335 and end windings 806. End windings 806 may be cooled by contact with the coolant fluid. Therefore, cooling system 304 may cool at least some components of rotor assembly 302 and at least some components of stator assembly 802.

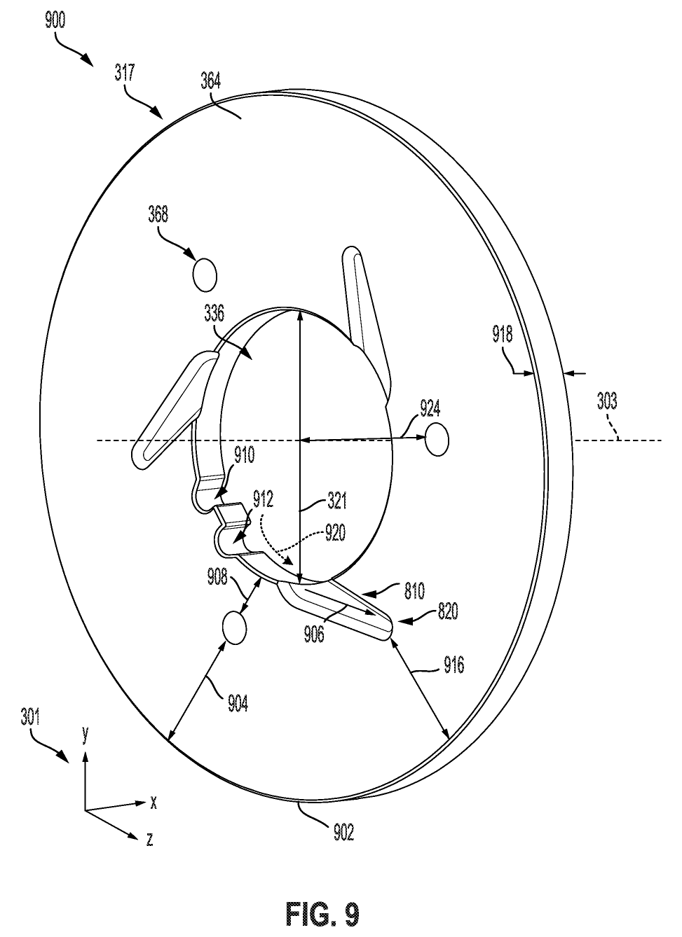

Turning to FIG. 9, a view 900 of an example of second end cap 317 is shown. Specifically, inner surface 364 is shown with openings to third cooling channels 368 and fourth cooling channels 810.

Second end cap 317 includes opening 336, as described above. Opening 336 may be sized to accommodate second flange 343 of end drive coupling 350 of FIGS. 3 and 8. As such, the diameter of the opening 336 may be the same as diameter 321 of FIG. 3.

Third cooling channels 368 may be a distance 924 from axis 303, where the distance 924 may be approximately equal to the distance 624 of FIG. 6 and the distance 724 of FIG. 7. Third cooling channels 368 may extend axially through an entire thickness 918 of second end cap 317. Thickness 918 may be approximately the same as thickness 618 of first end cap 316 shown in FIGS. 6 and 7. Third cooling channels 368 may be spaced away from opening 336 by a distance 908. Additionally, third cooling channels 368 may be spaced away from outer edge 902 of second end cap 317 by a distance 904. For example, the outer edge 902 may have the same diameter as outer edge 602 of first end cap 316 of FIGS. 6 and 7. Distance 904 may be approximately the same as distance 604 between outer edge 602 and third cooling channels 368 in first end cap 316 shown in FIGS. 6 and 7. Further, distance 908 may be approximately the same as distance 708 between third cooling channels 368 and first flange 342.

As described above, fourth cooling channels 810 may extend through drive end coupling 350 via opening 818 of FIG. 8, and through second end cap 317 via opening 820. Fourth cooling channels 810 may extend partially through thickness 918. For example, opening 820 may comprise an indent in inner surface 364 extending from opening 336 towards outer edge 902 along a direction 906 at a non-zero, non-orthogonal angle with axial, and radial directions. For example, the direction 906 may be approximately tangential with opening 336 such that fluid flowing in direction 920 due to rotation about the axis 303 in a counterclockwise direction with respect to the view 900 may continue smoothly through fourth cooling channels 810. In this way, fourth cooling channels 810 may guide coolant fluid from opening 336 to stack cooling channels 335 of FIGS. 3 and 8 as described above. For examples where rotation occurs oppositely (e.g., clockwise as opposed to counterclockwise), the direction 906 may be angled oppositely accordingly. Opening 820 may be spaced away from outer edge 902 by a distance 916 approximately equal to distance 904. In this way, third cooling channels 368 and fourth cooling channels 810 may axially align with stack cooling channels 335 of FIGS. 3 and 8. Third cooling channels 368 and fourth cooling channels 810 may be arranged in an alternating pattern around opening 336.

Second end cap 317 may further comprise semicircular extensions 910, 912 from opening 336. Extensions 910, 912 may be formed as artifacts from manufacturing features of second end cap 317. In some examples, extensions 910, and 912 may be moved or absent depending on the manufacturing process. For example, drive end coupling 350 of FIGS. 3 and 8 may comprise complementary protrusions that fit into extensions 910, 912, interlocking and rotationally coupling end cap 317 with drive end coupling 350 in the assembly 302 of FIGS. 3, 8, and 11.

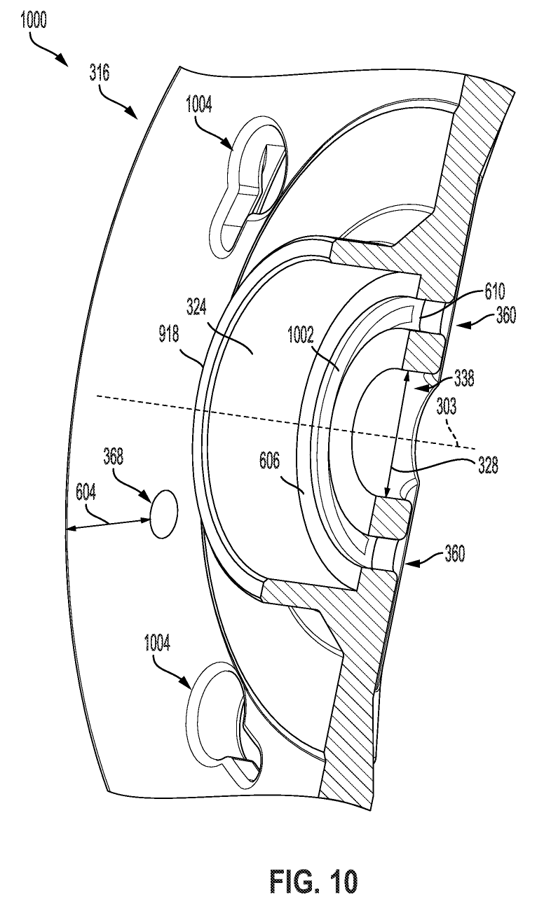

Turning to FIG. 10, another example of first end cap 316 is shown in a cross section view 1000. In the example of FIG. 10, second cooling channels 362 of FIGS. 3 and 6-8 for delivering fluid to cavity 306 may not be included. Additionally, first channels 360 are spaced away from the protrusion 344, rather than intersecting the protrusion 344 as described above with regards to the example in FIG. 6. Specifically, outer openings 610 of first cooling channels 360 may be formed in annular portion 606 of outer surface 366 and spaced away from inner surface 324 of protrusion 344. In examples where first cooling channels 360 and second cooling channels 362 are included, outer openings of both first cooling channels 360 and second cooling channels 362 may be spaced away from protrusion 344.

To guide fluid to first channels 360, outer openings 610 may be located along a ring 1002. The ring 1002 may be a ring-shaped indent interposed between hole 338 and protrusion 344. Due to outer openings 610 being located within ring 1002, fluid may flow through outer openings 610 into cooling channels 360, despite being spaced away from inner surface 324 wheretoward fluid is forced during rotation of the rotor assembly. Inner openings of first cooling channels 360 (e.g., inner openings 710) may be shaped with outward radial elongation as shown in FIG.7 so as to passively direct fluid radially outward.

First end cap 316 may further include holes 1004 radially arranged and alternating with third cooling channels 368. Holes 1004 may be used gripping of first end cap 316 during automated assembly of the electric motor.

First end cap 316 may vary from the examples provided in FIGS. 6, 7, and 10 without departing from the scope of the present disclosure. For example, some alternative examples of end cap 316 may include both second cooling channels 362 and holes 1004. Additionally or alternatively, there may be greater or fewer of the cap cooling channels (e.g., first cooling channels 360, second cooling channels 362, third cooling channels 368) and holes (e.g., holes 1004) than shown.

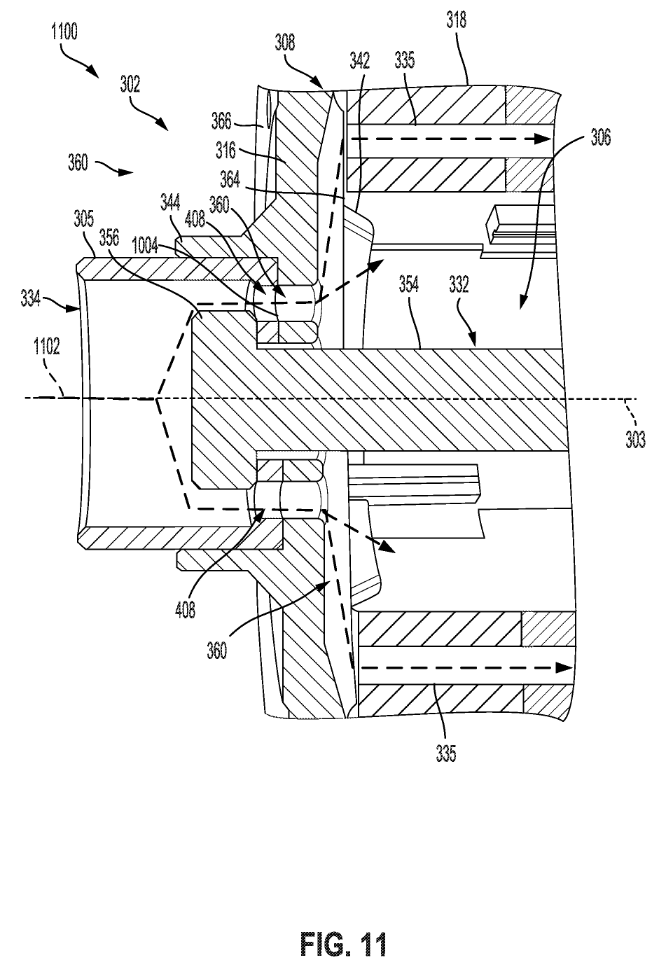

Turning to FIG. 11, a cross section view 1100 is shown of part of rotor assembly 302 including the example of first end cap 316 of FIG. 10 comprising two or more first cooling channels 360 spaced away from protrusion 344. A path 1102 of fluid flow is shown through cup 305, first end cap 316, and lamination stacks 318.

Similar to the example in FIG. 3, fluid may enter the rotor assembly 302 via axially outer opening 334 of cup 305. Though not shown in FIG. 11, there may be a fluid plug such as fluid plug 340 of FIGS. 3 and 8 positioned within cup 305 and configured to prevent backflow. Fluid may flow around head 356 to cooling passages of cup 305 where fluid may exit cup 305.

As described with regards to FIGS. 3 and 8, cooling passages of cup 305 may be axially aligned with first cooling channels 360 such that fluid flows continuously therethrough. For example, cooling holes 408 may axially align with outer openings 610. Alternatively, in examples where the cooling passages include cooling slots 502 of FIG. 5, outer openings 610 may axially align therewith.

As described above, first cooling channels 360 may direct fluid radially outward toward stack cooling channels 335 due to radially elongated inner openings (e.g., first inner openings 710 of FIG. 7). First cooling channels 360 may be angled with respect to axis 303 and radial directions outward therefrom. Fluid may also flow from first cooling channels 360 into cavity 306, in at least some examples. From stack cooling channels 335, fluid may flow to second end cap 317 and be channeled out of rotor assembly 302 or back into stack cooling channels 335 via fourth cooling channels 810, as described with reference to FIG. 8.

In this way, cap cooling channels in end cap 316 of rotor assembly 302 may direct fluid throughout the rotor assembly 302, including through lamination stacks 318 and cavity 306 which is surrounded by lamination stacks 318. In this way, at least parts of rotor assembly 302 may be cooled, reducing heat induced degradation during operation as part of an electric machine such as the electric machine 14 of FIG. 1. FIGS. 1-11 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The technical effect of the rotor assembly and cooling system of the present disclosure incorporated therein is to provide heat mitigation to components of the rotor assembly by flowing coolant fluid through cooling channels in the rotor assembly. The cooling channels may include stack cooling channels for axial flow through a rotor core of the rotor assembly, and cap cooling channels adapted to distribute coolant fluid to the stack cooling channels and a cavity surrounded by the rotor core. Further, the cap cooling channels may facilitate coolant fluid exit from the rotor assembly such that the coolant fluid cools end windings of a stator surrounding the rotor assembly. In this way, the cooling system may deliver coolant fluid to the rotor assembly and the stator assembly, thereby reducing temperatures of at least some components of the rotor assembly and at least some components of the stator assembly.

The disclosure also provides support for a rotor assembly, comprising: a first end cap, a second end cap, a rotor core surrounding a cavity and positioned between the first end cap and the second end cap, and a fastener extending axially along an axis through the first end cap, the second end cap, and the cavity, the fastener affixing the first end cap and the second end cap to the rotor core, where the first end cap and the second end cap have cap cooling channels to distribute a coolant fluid among stack cooling channels extending axially through the rotor core. In a first example of the system, the cap cooling channels include first cooling channels at a first angle with the axis. In a second example of the system, optionally including the first example, the cap cooling channels further include second cooling channels at a second angle greater than the first angle with the axis. In a third example of the system, optionally including one or both of the first and second examples, the cap cooling channels further include third cooling channels parallel with the axis and the coolant fluid exits the rotor assembly via the third cooling channels. In a fourth example of the system, optionally including one or more or each of the first through third examples, the cap cooling channels further include fourth cooling channels that redirect the coolant fluid in an opposite axial direction from which fluid enters the fourth cooling channels. In a fifth example of the system, optionally including one or more or each of the first through fourth examples, some of the stack cooling channels are axially aligned with the first cooling channels at a first end and with the third cooling channels at a second end, and others of the stack cooling channels are axially aligned with the fourth cooling channels at the second end and with the third cooling channels at the first end. In a sixth example of the system, optionally including one or more or each of the first through fifth examples, the coolant fluid does not flow radially through the rotor core.

The disclosure also provides support for a rotor assembly, comprising: a rotor core including lamination stacks surrounding a cavity and centered around an axis, a first end cap at a first end of the rotor core, the first end cap including a protrusion adapted to receive a cup, a second end cap at a second end of the rotor core, and a cooling system, comprising: cooling holes or cooling slots in the cup, where fluid enters the rotor assembly via the cooling holes or cooling slots, stack cooling channels through which the fluid flows axially within the lamination stacks, and cap cooling channels through which the fluid flows within the first end cap and the second end cap. In a first example of the system, the cap cooling channels include first cooling channels formed in the first end cap, second cooling channels formed in the first end cap, third cooling channels formed in the first end cap and in the second end cap, and fourth cooling channels formed in the second end cap. In a second example of the system, optionally including the first example, the first cooling channels include first inner openings that are outwardly radially elongated to deliver the fluid to the stack cooling channels, and the second cooling channels include second inner openings that are outwardly radially elongated to deliver the fluid to a perimeter of the cavity. In a third example of the system, optionally including one or both of the first and second examples, a first number of the first cooling channels, a second number of the second cooling channels, and a third number of the third cooling channels of the first end cap are equal. In a fourth example of the system, optionally including one or more or each of the first through third examples, the cooling holes are radially arranged around the axis and fluidly separated from an axially inner opening of the cup. In a fifth example of the system, optionally including one or more or each of the first through fourth examples, the cooling slots are radially arranged around the axis and fluidly coupled to an axially inner opening of the cup. In a sixth example of the system, optionally including one or more or each of the first through fifth examples, the rotor assembly further comprises a fastener extending axially through a center of the first end cap, through the cavity, and through a center of the second end cap, the fastener affixing the first end cap and the second end cap to the rotor core without any other fasteners. In a seventh example of the system, optionally including one or more or each of the first through sixth examples, the fluid flows in a first axial direction through some of the stack cooling channels and in a second axial direction through others of the stack cooling channels, the first axial direction being opposite the second axial direction. In an eighth example of the system, optionally including one or more or each of the first through seventh examples, the first end cap includes a first flange, the second end cap includes a through hole adapted to receive a drive end coupling with a second flange, and the first flange and the second flange extend axially towards each other to axially align the lamination stacks. In a ninth example of the system, optionally including one or more or each of the first through eighth examples, the cooling system is adapted to distribute the fluid through the rotor assembly and to end windings of a stator assembly circumferentially surrounding the rotor assembly.

The disclosure also provides support for an electric machine, comprising: a stator assembly including stator lamination stacks and conductors extending through the stator lamination stacks, the conductors including end windings extending beyond the stator lamination stacks, and a rotor assembly adapted to rotate about an axis, the rotor assembly comprising: a first end cap and a second end cap, a rotor core circumferentially surrounded by the stator lamination stacks and positioned axially between the first end cap and the second end cap, and a fastener extending along the axis and adapted to apply axial force on the first end cap and second end cap, wherein stack cooling channels extend axially through the rotor core parallel to the axis and cap cooling channels extend through the first end cap and the second end cap, and wherein the cap cooling channels are adapted to distribute coolant fluid to the stack cooling channels and distribute fluid to the end windings. In a first example of the system, the rotor assembly further comprises a cup including an axially outer opening, an axially inner opening, and cooling holes or cooling slots radially arranged around the axially inner opening. In a second example of the system, optionally including the first example, the cooling holes or the cooling slots axially align with the cap cooling channels formed in the first end cap.

In another representation a hybrid vehicle comprises an electric machine including a rotor assembly and a stator circumferentially surrounding the rotor assembly, wherein the rotor assembly comprises: a first end cap; a second end cap; a rotor core surrounding a cavity and positioned between the first end cap and the second end cap; and a fastener extending axially along an axis through the first end cap, the second end cap, and the cavity, the fastener affixing the first end cap and the second end cap to the rotor core, where the first end cap and the second end cap have cap cooling channels to distribute a coolant fluid among stack cooling channels extending axially through the rotor core.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A rotor assembly, comprising:
a first end cap;
a second end cap;
a rotor core surrounding a cavity and positioned between the first end cap and the second end cap; and
a fastener extending axially along an axis through the first end cap, the second end cap, and the cavity, the fastener affixing the first end cap and the second end cap to the rotor core, where the first end cap and the second end cap have cap cooling channels to distribute a coolant fluid among stack cooling channels extending axially through the rotor core.

2. The rotor assembly of claim 1, wherein the cap cooling channels include first cooling channels at a first angle with the axis.

3. The rotor assembly of claim 2, wherein the cap cooling channels further include second cooling channels at a second angle greater than the first angle with the axis.

4. The rotor assembly of claim 2, wherein the cap cooling channels further include third cooling channels parallel with the axis and the coolant fluid exits the rotor assembly via the third cooling channels.

5. The rotor assembly of claim 4, wherein the cap cooling channels further include fourth cooling channels that redirect the coolant fluid in an opposite axial direction from which fluid enters the fourth cooling channels.

6. The rotor assembly of claim 5, wherein the stack cooling channels are axially aligned with the first cooling channels at a first end and with the third cooling channels at a second end, or are axially aligned with the fourth cooling channels at the second end and with the third cooling channels at the first end.

7. The rotor assembly of claim 1, wherein the coolant fluid does not flow radially through the rotor core.

8. A rotor assembly, comprising:
a rotor core including lamination stacks surrounding a cavity and centered around an axis;
a first end cap at a first end of the rotor core, the first end cap including a protrusion adapted to receive a cup;
a second end cap at a second end of the rotor core; and
a cooling system, comprising:
cooling passages in the cup, where fluid enters the rotor assembly via the cooling passages;
stack cooling channels through which the fluid flows axially within the lamination stacks; and
cap cooling channels through which the fluid flows within the first end cap and the second end cap.

9. The rotor assembly of claim 8, wherein the cap cooling channels include first cooling channels formed in the first end cap, third cooling channels formed in the first end cap and in the second end cap, and fourth cooling channels formed in the second end cap, and wherein the first cooling channels include first inner openings that are outwardly radially elongated to deliver fluid to the stack cooling channels.

10. The rotor assembly of claim 9, wherein the cap cooling channels further include second cooling channels with second inner openings that are outwardly radially elongated to deliver the fluid to a perimeter of the cavity.

11. The rotor assembly of claim 9, wherein a first number of the first cooling channels, a second number of second cooling channels formed in the first end cap, and a third number of the third cooling channels of the first end cap are equal.

12. The rotor assembly of claim 8, wherein the cooling passages include cooling holes, and wherein the cooling holes are radially arranged around the axis and fluidly separated from an axially inner opening of the cup.

13. The rotor assembly of claim 8, wherein the cooling passages include cooling slots, and wherein the cooling slots are radially arranged around the axis and fluidly coupled to an axially inner opening of the cup.

14. The rotor assembly of claim 8, wherein the rotor assembly further comprises a fastener extending axially through a center of the first end cap, through the cavity, and through a center of the second end cap, the fastener affixing the first end cap and the second end cap to the rotor core without any other fasteners.

15. The rotor assembly of claim 8, wherein the fluid flows in a first axial direction through some of the stack cooling channels and in a second axial direction through others of the stack cooling channels, the first axial direction being opposite the second axial direction.

16. The rotor assembly of claim 8, wherein the first end cap includes a first flange, the second end cap includes a through hole adapted to receive a drive end coupling with a second flange, and the first flange and the second flange extend axially towards each other to axially align the lamination stacks.

17. The rotor assembly of claim 8, wherein the cooling system is adapted to distribute the fluid through the rotor assembly and to end windings of a stator assembly circumferentially surrounding the rotor assembly.

18. An electric machine, comprising:
a stator assembly including stator lamination stacks and conductors extending through the stator lamination stacks, the conductors including end windings extending beyond the stator lamination stacks; and
a rotor assembly adapted to rotate about an axis, the rotor assembly comprising:
a first end cap and a second end cap;
a rotor core circumferentially surrounded by the stator lamination stacks and positioned axially between the first end cap and the second end cap; and
a fastener extending along the axis and adapted to apply axial force on the first end cap and second end cap, wherein stack cooling channels extend axially through the rotor core parallel to the axis and cap cooling channels extend through the first end cap and the second end cap, and wherein the cap cooling channels are adapted to distribute coolant fluid to the stack cooling channels and distribute fluid to the end windings.

19. The electric machine of claim 18, wherein the rotor assembly further comprises a cup including an axially outer opening, an axially inner opening, and cooling holes or cooling slots radially arranged around the axially inner opening.

20. The electric machine of claim 19, wherein the cooling holes or the cooling slots axially align with the cap cooling channels formed in the first end cap.
